(19) United States
(12) Patent Application Publication
(10) Pub. No.: US 2013/0319571 A1
(43) Pub. Date: Dec. 5, 2013

(54) COMPOSITE PIPE

(71) Applicant: Todd A. Volker, Overland Park, KS (US)

(72) Inventor: Todd A. Volker, Overland Park, KS (US)

(21) Appl. No.: 13/895,513

(22) Filed: May 16, 2013

Related U.S. Application Data
(60) Provisional application No. 61/654,327, filed on Jun. 1, 2012.

(51) Int. Cl. F16L 9/16; F16L 9/12

(52) U.S. Cl. CPC F16L 9/16; F16L 9/123
USPC 138/144; 156/187; 156/443

(57) ABSTRACT

A composite pipe and method of manufacture comprises an inner core made of a resinous material, a prepreg material helically wound about the inner core and an outer shell covering the wound prepreg materials. The materials are applied at preselected melt temperatures to assure coherence among the materials and preclusion of voids and/or annuli therebetween. A cooling of the inner pipe core during initial application of the tape layer of prepreg materials stabilizes the radial configuration of the pipe core during tape wrapping and thus the appearance of undesirable voids and/or annuli in the composite pipe mass.

### CROSS REFERENCE TO RELATED APPLICATION

This application claims the benefit of co-pending provisional application Ser. No. 61/654,327, filed Jun. 1, 2012.

### BACKGROUND

This invention relates to a composite pipe and the manufacture thereof

Flexible and rigid pipes are commonly used to transport various types of fluids or gases. The pipes comprise a plurality of materials joined together in various manners to form a conduit for advance of the fluid and/or gas materials therethrough.

The use of the extrusion process to form a pipe having multiple material layers is known. Various disadvantages with the extrusion process have arisen including the possibility of variances in the pipe thickness over the length of the pipe and radial/hoop expansion of the pipe during the manufacturing process. Such actions may cause internal deformities leading to leakage and/or burst during fluid and/or gas transport. Also, longitudinal movement between the material layers will cause abrasion therebetween resulting in premature wear and possible pipe failure. Moreover, in past pipes annuli and/or voids may appear between the pipe layers. If not properly vented, undesirable permeation of the gases of the transported fluid and/or gas into these areas may occur, which may lead to pipe failure.

In response thereto a coherent, multi-layer pipe is desired which avoids the above problems. A method of pipe manufacture is presented, which provides a coherent bond among the material layers so as to present a unitary mass of material with no voids therein as well as longitudinal or radial movement therebetween. The process is enhanced by a cooling of the extruded pipe core during the subsequent wrapping of intermediate reinforcing layers of a resinous prepreg or similar material. This cooling precludes expansion and contraction of the pipe core and thus the appearance of undesirable annuli or voids between the material layers. Accordingly, the bonding presents a cohered multi-layer pipe, which has various desirable properties including chemical, pressure and pressure resistance, the preclusion of annuli and/or voids between material layers and resistance to lateral and radial layer movement.

It is therefore a general object of the invention to provide a versatile composite pipe and method of manufacture for effectively transporting pressurized fluids or gases therethrough.

Another object of this invention is to provide a composite pipe and method of manufacture, as aforesaid, having a plurality of layered materials cohered into a unitary mass.

A further object of this invention is to provide a composite pipe and method of manufacture, as aforesaid, which precludes the appearances of voids and annuli between the material layers.

Still another object of this invention is to provide a composite pipe having a method of manufacture, as aforesaid, which precludes undesirable radial movement of the inner core during pipe manufacture and subsequent application of the material layers.

Another particular object of this invention is to provide a composite pipe, as aforesaid, having no free floating fibers within the pipe mass.

Still a further object of this invention is to provide a composite pipe, as aforesaid, which can be effectively butt fused in the field.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a block diagram showing the manufacturing process;

FIG. 2 illustrates one form of the cooling apparatus for the pipe core; and

FIG. 3 illustrates another form of the cooling apparatus for the inner pipe core.

### DESCRIPTION

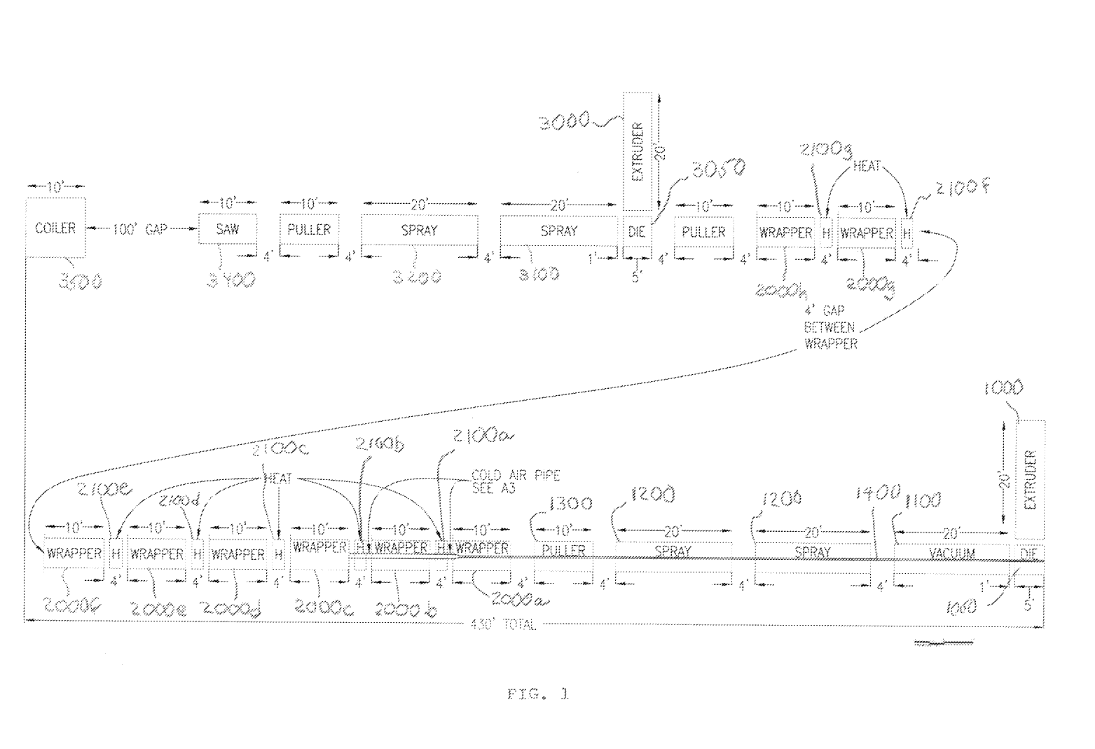

Turning more particularly to the drawings, FIG. 1 illustrates the basic manufacture of the composite pipe so as to present a composite pipe having the above-described advantages.

Pipe includes an inner core 110, which is formed by a conventional extrusion process initiated at extruder 1000. The utilized material is preferably a high density thermoplastic PE 4710 industrial polythene material. The advantages of such a material are a good chemical resistance, high impact resistance, good abrasion resistance, low weight and ease of coupling. At this time, longitudinal tape having Fiberglas® strands or other materials may be introduced into the thickness of core 110, via extruder 1000, to provide longitudinal support therealong. The outer coating 120 of the core 110 presents a thin polyethylene material having a lesser density with a melt temperature of approximately 230° F. This melt temperature approximates the melt temperature of the resin in the prepreg tape material to be subsequently wrapped about the inner core 110 at stations 2000a-20000h.

Subsequent to the extrusion process at 1000 the pipe core 110 passes through a conventional vacuum/cooling tank 1100, which sizes the pipe to its desired outside diameter. Sprayers 1200 cool the core 110 towards an ambient temperature. Puller 1300 directs the relatively rigid pipe core 110 downstream so that proper line speed and pipe stabilization can be achieved.

Subsequently, tape layers of a prepreg or similar material having Fiberglas® strands therein are to be helically wound in opposed directions about the inner core. One form of the tape is as discussed in the Dyksterhouse patent U.S. 6,524,690. My tape currently comprises a 35% polyethylene, 5% moleic anhydride and 60% Fiberglas® mixture. It is understood that other materials may be used in lieu of Fiberglas®, particularly those to provide a strengthening effect and/or enhance conductivity during various forms of heating. Carbon black or other material suitable for induction heating may also be utilized to enhance the heating process, particularly if microwaves are to be used. The melt temperature of the polyethylene resin in the tape approximates 230° F. similar to the melt temperature of the outer coating 120 of the pipe core 110.

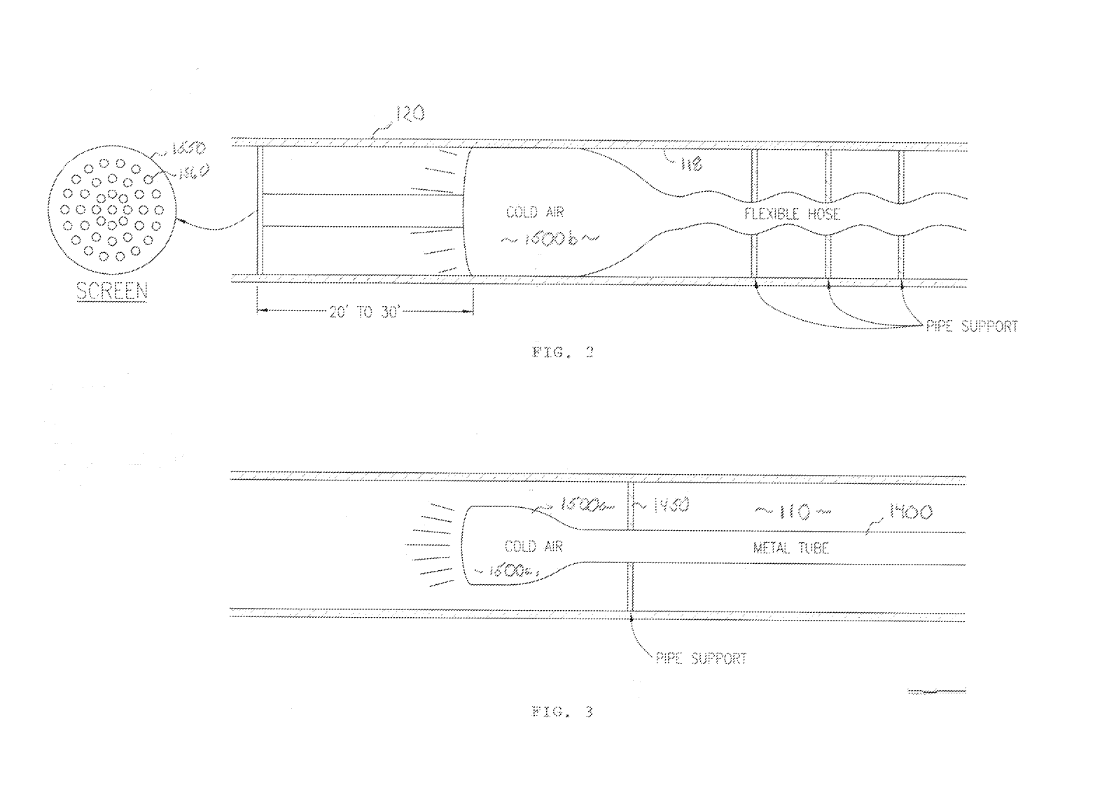

During the wrapping process cooler air is to be introduced into the interior of the pipe core 110 by apparatus as shown in FIG. 2 or 3. The cooler air stabilizes the pipe core 110 so minimal expansion and subsequent contraction, if any, will occur during the subsequent wrapping and heating processes. Heretofore, the disadvantages of such radial movements of the pipe core 110 have not been considered. Undesirable voids may appear between the pipe core 110 and subsequent tape layers during the wrapping process as radial movement of the heated core 110 may cause displacement from the applied wraps. Thus, it is desirable to maintain a temperature within the pipe core below the melt temperatures of the coating 120 and tape layers so as to preclude such radial movement. The cooling air temperature must not only cool the pipe core 110 but avoid crystallization of the pipe core 110 mass.

To achieve such cooling, an elongated conduit 1400 is inserted through a central aperture in the initial extrusion die 1050 so that it is centrally located within the inner core 110. The conduit 1400 follows the path taken by the inner core 110 through stations 1100, 1200, 1300 and at least two subsequent wrapping and heating stations. The conduit 1400 is supported within the core 110 and away from its inner wall 118 by a plurality of supports 1450 attached about the conduit 1400 at the downstream end thereof. The conduit supports 1450 are made of a slick material, e.g., acetal, to provide a maximum slippage between the stationary supports 1450 and interior surface 118 during movement of the pipe core 110. As such the inner core 110 is not inhibited in its downstream travel.

Cold air is introduced into the inner core 110 via nozzle 1500a or 1500b fixed at the end of pipe 1400. The nozzle terminus is preferably after the core 110 is helically wrapped with the first tape layer at station 2000a and prior to entry into the first heat station 2100a. Nozzle 1500 may be of various shapes and materials as shown in FIGS. 2 and 3. Cold air is introduced into the pipe 1400 at the opposed end by any suitable fan/refrigeration unit combination positioned upstream of die 1050.

A screen 1550 is positioned at the open end conduit 1400. Screen 1550 has a plurality of apertures 1560 therein so as to regulate the discharge of air from conduit pipe 1400. The number of apertures is selected so that the desired cooling temperature will be achieved as the core is wrapped and heated at stations 2000a, 2100a, 2000b and 2100b. The air discharge precludes a pressure buildup therein which may undesirably expand the inner core 110.

After each wrapping station 2000a-2000g, a heater 2100a-2100g raises the resin temperatures of the coating 120 and resin in the first and second helically-wrapped tape layers to their melt temperatures to insure a coherent bond therebetween. Such heat may be supplied by conventional film heat apparatus, e.g., microwave, infrared, laser induction heating, etc. The microwave process may be enhanced by impregnating carbon black fibers within the tape being wound about the exterior surface of the core.

During wrapping of the first two layers at stations 2000a, 2000b, the above-described cooling pipe apparatus 3000, as shown in FIGS. 2-3, introduces cool air into the inner pipe core so that the heat applied by heaters 2100a, 2100b does not expand the pipe core 110. At station 2000b, the tape is helically wound in an opposed direction about the first helical layer of the tape thus covering the exterior coating 120 of the pipe core 110. As such, temperature migration resulting from the heating of the helically-wrapped tape layers about the pipe core 110 is diminished, if not precluded. Thus, internal cooling of the pipe core 110 may no longer be needed beyond heat station 2100b. Subsequent layers of the prepreg or similar materials are helically wound in opposed directions about core 110. Heaters 2100a et seq. insure that the melt temperatures of the resin in the preceding tape layer and preceding contiguous layers are achieved to attain a coherent bond therebetween. As such, no voids appear in the mass surrounding the inner core 110. The absence of such voids/annuli precludes the confinement of gases within the pipe layers which may permeate from the pipe core. It is understood that future tapes may be developed wherein only one wrapping to cover the exterior coating 120 is needed.

After the last wrapping station 2000h, the pipe with tape layers therearound passes through a cross head overlay dye at 3050. An outer shell of a polyethylene 100 or similar material is extruded at 3000 to encompass the pipe and tape layers. The extended temperature of the resin in this outer shell is approximately 400° F. Thus, the resin in the preceding tape layers which are adjacent this outer shell will also reach their melt temperature such that a coherent bond is achieved between the exterior shell and preceding tape layers. As such, heat need not be applied after the last tape layer is wrapped about the inner core.

A composite pipe having a plurality of cohered layers with no voids and/or annuli therebetween are presented for cooling at stations 3100, 3200, cutting 3400 and coiling 3500.

It is understood that the above process enables flexible coil pipe to be manufactured up to diameters of six inches with rigid pipe of larger diameters. In either case it is necessary to join the pipe sections in the field at a minimal cost. The above-described pipe construction enables a cost-effective butt fusion therebetween. The end joints of the pipe sections are wound with the same or similar tape of prepreg materials as utilized in the wrapping process. Other types of wraps hereafter developed may be used. The tape and pipe ends are heated on site so as to provide cohesion therebetween. As such there is no need for expensive mechanical couplings or welding of the pipes in the field. Moreover, during this process the exterior surfaces of the pipe remain intact, which enhances the juncture between pipe sections.

It is understood that the interior surface of pipe core 110 may be fluorinated prior to the core 110 reaching the first wrapping station 2000a. Alternatively, an EVOH barrier material may also be applied. Such applications may preclude the need for subsequent wrapping in certain applications. If not, subsequent wrapping of the core 110 may still be required with the wraps being secured either by heating as above described or adhesives in lieu of heating.

It is to be understood that while certain forms of this invention have been illustrated and described, it is not limited thereto, except in so far as such limitations are included in the following claims.

Having thus described the invention, what is claimed as new and desired to be secured by Letters Patent is:

1. A composite pipe comprising:
an inner pipe core of a resinous material having an exterior resinous coating having a melt temperature;
at least two layers of tape comprising a resinous material having reinforcing fibers impregnated therein, a melt temperature of the tape resinous material at least the melt temperature of the exterior resinous coating of the inner pipe core;
first and second layers of said at least two tape layers being helically wound in opposed directions about said pipe core whereupon said melt temperatures of said pipe core coating and each layer of said at least two tape layers are attained to cohere said first and second layers of said at least two tape layers with said coating of said inner pipe core with no voids therebetween;
an outer shell of resinous material having a melt temperature at least said melt temperature of said at least two tape layers, said outer shell applied about contiguous layers of said at least two tape layers at a temperature sufficient to attain the melt temperature of said outer shell and layers of said at least two tape layers contiguous with said outer shell, whereupon to cohere said outer shell, said layers contiguous with said outer shell, said first and second layers of said at least two tape layers and said inner pipe core, whereby to preclude voids and relative movement therebetween.

2. The apparatus as claimed in claim 1 wherein an interior temperature of said inner pipe core is maintained at a temperature sufficient to preclude an undesirable radial movement of said inner pipe core during said helical winding of said at least two tape layers.

3. The apparatus as claimed in claim 1 wherein each layer of said at least two tape layers comprise a resinous material and strengthening fibers impregnated therein.

4. The apparatus as claimed in claim 1 wherein said composite pipe presents a free end adapted to be positioned contiguous a free end of another composite pipe as in claim 1 and further comprising:
a wrap of tape having a resinous material with reinforcing fibers impregnated therein, a melt temperature of said resinous material of said tape wrap at least the melt temperature of said resinous material of said at least two tape layers, said wrap of tape wound about said contiguous free ends of said respective composite pipes, whereupon said melt temperatures of said wrap of tape and said at least two tape layers about said respective composite pipes are attained for coherence therebetween, whereby to join said contiguous free ends of said respective composite pipes.

5. The apparatus as claimed in claim 1 further comprising additional layers of said tape helically wound about said first and second layers of said at least two layers of tape, each additional tape layer wound in a helical direction opposite an immediately preceding wound tape layer whereupon said melt temperatures of said resinous material in said additional wound tape layer and preceding contiguous tape layers are attained to cohere each additional tape layer with preceding contiguous tape layers with no voids and relative movement therebetween.

6. The apparatus as claimed in claim 1 further comprising:
means for maintaining said inner pipe core at a preselected temperature during said winding of at least the first and second layers of said at least two tape layers, said preselected temperature being less than said melt temperature of said exterior resinous coating of said inner pipe core, whereupon to preclude radial movement of said pipe core upon said first and second layers of said at least two tape layers being attained.

7. The apparatus as claimed in claim 6 wherein said maintaining means comprises:
means for introducing cooling air into said inner pipe core upon said winding of said first and second layers of said at least two tape layers.

8. The apparatus as claimed in claim 7 wherein said cooling means comprises:
an elongated conduit having first and second opposed ends, said conduit releasably positioned within said inner pipe core at a location prior to said melt temperature of said first tape layer being attained;
means for supporting said conduit within said inner pipe core;
blower means for injecting said cooling air into said first end of said elongated conduit, said cooling air discharged from said second end of said conduit into said inner pipe core, said cooling air precluding a radial movement of said inner pipe core upon said melt temperatures of said first and second layers of said at least two tape layers being attained.

9. The apparatus as claimed in claim 8 further comprising means at said second end of said conduit for precluding a buildup of said cooling air at said second conduit end, whereby to preclude an undesirable movement of said inner pipe core.

10. The apparatus as claimed in claim 9 wherein said precluding means comprises:
a cap at said second end of said conduit;
means associated with said cap for regulating a volume flow of said cooling air therethrough.

11. The apparatus as claimed in claim 10 wherein said regulating means comprises a plurality of apertures in said cap, the number of said apertures corresponding to a desired air flow of said cooling air through said cap.

12. A composite pipe comprising:
an inner pipe core of a resinous material having an exterior resinous coating having a melt temperature;
at least first and second layers of tape comprising a resinous material having reinforcing fibers impregnated therein, a melt temperature of the tape resinous material at least the melt temperature of the exterior resinous coating of the inner pipe core;
said first layer being helically wound about said pipe core, said first tape layer being cohered with said coating of said inner pipe core with no voids therebetween upon said melt temperatures of said pipe coating and said first tape layer being attained;
said second tape layer being helically wound in an opposed direction about said first tape layer and pipe core, whereupon said second tape layer being cohered with said first tape layer and said inner pipe core with no voids therebetween upon said melt temperatures of said layers and pipe core being attained;
an outer shell of resinous material having a melt temperature at least said melt temperature of said first and second tape layers, said outer shell applied about said inner core, said first and second layers at a temperature sufficient to attain the melt temperatures of said outer shell and layers of tape contiguous with said outer shell, wherein to cohere said outer shell, said tape layers and said inner pipe core with the preclusion of voids and relative movement therebetween.

13. The apparatus as claimed in claim 12 wherein an interior temperature of said inner pipe core is maintained sufficient to preclude an undesirable radial movement of said inner pipe core during said helical winding of said at least first and second tape layers.

14. The apparatus as claimed in claim 12 wherein each layer of said at least two tape layers comprise a resinous material and Fiberglas® fibers impregnated therein.

15. The apparatus as claimed in claim 12 wherein said subsequent tape layers comprise additional layers of said tape helically wound about first and second layers of tape, each additional tape layer wound in a helical direction opposite an immediately preceding wound tape layer, said each additional tape layer being in coherence with previous tape layers upon said melt temperatures of said resinous material in contiguous tape layers being attained, whereupon to cohere each additional tape layer with preceding contiguous tape layers with no voids therebetween.

16. The apparatus as claimed in claim 12 further comprising:
means for maintaining said inner pipe core at a preselected temperature during said winding of said first and second tape layers, said preselected temperature being less than said melt temperature of said exterior resinous coating of said inner pipe core, whereupon to preclude radial movement of said pipe core during said winding of said first and second tape layers.

17. The apparatus as claimed in claim 16 wherein said maintaining means comprises:
means for introducing cooling air into said inner pipe core during said winding of said first and second tape layers.

18. The apparatus as claimed in claim 17 wherein said cooling means comprises:
an elongated conduit having first and second opposed ends, said conduit releasably positioned within said inner pipe core prior to said melt temperature of said wound first tape layer being attained;
means for supporting said conduit within said inner pipe core;
blower means for injecting said cooling air into said first end of said elongated conduit, said cooling air discharged from said second end of said conduit into said inner pipe core, said cooling air precluding a radial movement of said inner pipe core during said winding of said first tape layer.

19. In the process of forming a composite pipe having an inner pipe core of a resinous material with at least one layer of tape comprising a similar resinous material with strengthening fibers therein being sequentially wound about and melded with the pipe core, the improvement comprising:
an elongated conduit having first and second opposed ends, said conduit releasably positioned within said inner pipe core prior to said melding of said at least one tape layer with said pipe core;
means for supporting said conduit within said inner pipe core;
blower means for injecting a cooling air into said first end of said elongated conduit, said cooling air discharged from said second end of said conduit into said inner pipe core prior to said melding of said at least one tape layer, said cooling air precluding a radial movement of said inner pipe core during said melding of at least said at least one tape layer with said inner pipe core.

20. The apparatus as claimed in claim 19 further comprising means at said second end of said conduit for precluding a buildup of said cooling air at said second conduit end whereby to preclude an undesirable expansion of said inner pipe core.
